(19) United States
(12) Patent Application Publication
(10) Pub. No.: US 2026/0301490 A1
(43) Pub. Date: Oct. 1, 2026

(54) NEAR FIELD COMMUNICATIONS READER WITH SELECTABLE COMMANDS FOR VEHICLES

(71) Applicant: FORD GLOBAL TECHNOLOGIES, LLC, DEARBORN, MI (US)

(72) Inventors: Pietro Buttolo, Dearborn Heights, MI (US); David M. Hancock, South Rockwood, MI (US); Michael Duke, Livonia, MI (US)

(21) Appl. No.: 19/096,924

(22) Filed: Apr. 1, 2025

(51) Int. Cl. G07C 9/00; B60R 25/24; H04W 4/80

(52) U.S. Cl. CPC G07C 9/00309; B60R 25/24; B60R 2325/103; G07C 2009/00325; H04W 4/80

(57) ABSTRACT

A vehicle security apparatus responds to a near field communication (NFC) tag. An NFC reader has an antenna establishing an NFC pairing region. Receiver circuitry for decoding NFC signals when the NFC tag is positioned in the NFC pairing region an awake mode and a sleep mode. A plurality of proximity sensors are configured to detect presence of the NFC tag according to a plurality of subregions within the NFC pairing region, wherein the proximity sensors detect presence of the NFC tag independently of any NFC signals. A control circuit is configured to (1) change the receiver circuitry from the sleep mode to the awake mode when the proximity sensors detect the NFC tag in the NFC pairing region, and (2) select a user security command to be accessed using the NFC tag according to at least one of the subregions where the proximity sensors detected the NFC tag.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to automotive security systems, and, more specifically, to a security system with an NFC card reader for obtaining access to, and controlling activation of, a transportation vehicle such as a passenger automobile.

Keyless entry and push button start are popular features on passenger vehicles, such as cars and trucks. Instead of a traditional mechanical key, a user carries a device (e.g., a key fob or a smartphone) which wirelessly authenticates the user to gain access to the vehicle (e.g., door unlocking), to activate the vehicle (e.g., ignition of a combustion engine or activating an electric vehicle powertrain), and to perform other functions.

Near field communications (NFC) is one type of wireless interface being used because the very short transmission range makes it difficult for third parties to intercept and copy security data. A portable NFC unit (i.e., tag) kept in possession of an authorized user can be static (always responding with the same predetermined code) or dynamic (having computing power to perform a secure handshake with an NFC reader on the vehicle). It may operate using its own power source (e.g., a battery) or by harvesting energy from the NFC reader (e.g., inductive coupling).

NFC hardware is included in many smartphones, so that an appropriate app installed on the smartphone can be configured to operate as a smart key for the user. In addition, dedicated NFC-based key fobs are also in use. Key fobs may include small and thin objects such as an access card (e.g., shaped like a credit card) embedded with a batteryless RFID device which obtains its power from the vehicle during a reading operation. Digital key protocols maintain vehicle security while enabling sharing and management of vehicle access. For example, a Digital Key standard has been published by the Car Connectivity Consortium. As used herein, “NFC tag” refers to any portable unit carried by a user and capable of NFC communication with the vehicle-mounted NFC reader.

For an NFC-based security system of a vehicle, the portable NFC tag carried by the user communicates with a fixed NFC unit (e.g., an NFC card reader) mounted to the vehicle. NFC readers for controlling access to the vehicle (e.g. for unlocking/locking a door) may be mounted at several locations around the vehicle such as on the B-pillar (e.g., on the vertical pillar located between the windows of a front door and a rear door on one or both sides of the vehicle) and/or adjacent a trunk lid or liftgate. The NFC reader may comprise a transceiver with an RF antenna, signal drivers, and controller logic for interfacing with the portable NFC tag. Challenges in implementing an NFC reader on a vehicle include power consumption and performance latency.

When a vehicle is parked and unattended, it is important to keep electrical power consumption very low in order to preserve sufficient battery capacity for vital functions and to enable ignition startup when a user returns to use the vehicle. Power consumption for an NFC reader in an active reading mode can exceed the maximum allowed quiescent current draw when the vehicle is in a Key Off mode (a typical limit may be about 100μA). In order to reduce an average current consumption in Key Off mode, each NFC reader antenna is typically turned off and then periodically pulsed on for a short window at regular intervals (e.g., once every 100ms) to check whether an NFC tag responds to the pulse. In some cases, the pulsing may be slowed down to an even longer interval (e.g., once every 500ms) when the Key Off mode persists over longer periods of time. When an NFC tag is detected then the NFC reader may enter a fully powered-on mode to authenticate the NFC tag.

The use of a polling interval for reducing power consumption has the potential side effect of lengthening the response time for obtaining an unlocking of the vehicle when the user presents the NFC tag to the NFC reader. In particular, the polling interval introduces additional latency on top of whatever is needed to communicate and authenticate the tag and subsequently forward a vehicle access request (i.e., command) to the appropriate security modules (e.g., door locks). A total latency may be between 100ms and 500ms, for example, depending on vehicle power mode. Delays in obtaining the desired action(s) may be unsatisfactory to the user.

Another shortcoming of prior NFC readers has been in a lack of easy ways for a user to select between different commands or actions using the NFC tag. It has been proposed to distinguish between a shorter tap (in which the tag is withdrawn from the reader within a predetermined interval) as a command for unlocking a single door adjacent the reader, and a longer tap (in which the tag is held adjacent the reader for longer than the predetermined interval) for unlocking all doors (known as a global unlock). However, ensuring correct interpretation requires the user to place the card close to the reader for an undesirably long time period (about 3-4 seconds).

### SUMMARY OF THE INVENTION

In one aspect of the invention, a security apparatus is provided for a vehicle which is responsive to a near field communication (NFC) tag. An NFC antenna is disposed at an outer surface of the vehicle establishing an NFC pairing region. Receiver circuitry is coupled to the antenna and configured to decode NFC signals from the NFC tag when the NFC tag is positioned in the NFC pairing region, wherein the receiver circuitry has an awake mode for receiving the NFC signals and a sleep mode in which the NFC signals are not received. A plurality of proximity sensors are configured to detect presence of the NFC tag according to a plurality of subregions within the NFC pairing region, wherein the proximity sensors detect presence of the NFC tag independent of any NFC signals. A control circuit is configured to (1) change the receiver circuitry from the sleep mode to the awake mode in response to the proximity sensors detecting the NFC tag in the NFC pairing region, and (2) select a user security command to be accessed using the NFC tag according to at least one of the subregions where the proximity sensors detected the NFC tag.

Thus, the invention uses multiple proximity sensors, and the proximity sensors can use any kind of object detection/tracking, such as capacitive, ultrasound, infrared, inductive, or visible image. Capacitive sensing may be the most economical in terms of packaging, material, and power efficiency. The capacitive sensing may use single electrode sensors or multiple electrodes. A mutual capacitance implementation can be adopted for improved robustness to environmental noise.

The proximity sensors can be integrated with an NFC reader in different ways. One option is to configure a PCB board on which the NFC antenna is deposited to provide enough space around the antenna to deploy the capacitive (or other types of) sensors. In some embodiments, each respective proximity sensor may be associated with a corresponding security request. For example, when two proximity sensors are available, a detection closest to one sensor could be associated with an unlock request, while a detection closest to the other sensor is associated with a lock request. Special graphics, texture, symbols, or backlighting could be used on the Class A surface of the vehicle close to each proximity sensor to inform the user where to tap the NFC tag to obtain the corresponding security request.

In one typical sequence of events, a user may tap an NFC tag over the left side of the antenna while the proximity sensors are monitoring for objects entering the corresponding region (the sensors could monitor intermittently in a polling sequence). When the proximity sensor at the left side of the antenna detects the object, then the NFC antenna and receiver circuits are turned on in order to perform a handshake with the NFC tag. If authentication is successful, then a request is sent to the vehicle module(s) which carry out the specified action(s).

In some embodiment, after authentication a final position of the NFC tag can be determined by the proximity sensors. If a swiping motion is detected from one sensor to another sensor then this can be interpreted as a gesture signifying the requested action. For example, swiping left to right could request a global unlock command while swiping right to left could request a trunk unlock.

Because proximity sensors can be very energy efficient, they can be polled at a higher rate (e.g., every 20msec) without excessive current draw than the rate that can be supported by the NFC reader, thus reducing thus the latency of NFC detection and the average power consumption.

When no tag or other object is present at the NFC reader, only the proximity sensors are active. The NFC reader only turns on once an NFC tag is potentially present. In order to limit EMI (electromagnetic interference) generated by the proximity sensors from impacting the NFC communication, when an object is detected in proximity then both the NFC antenna is turned on and the proximity sensors are turned off. If an NFC tag is successfully authenticated, then the proximity sensors can be turned back on to confirm a location of the tag relative to the sensors (i.e., gesture detection). Additionally, if commands corresponding to a long tap are available, then the proximity sensors and the NFC reader can be alternately turned on and off in a pattern.

In some embodiments of a capacitive sensor, the NFC antenna conductor(s) can provide capacitive element(s) of the sensor. For example, the NFC antenna can be designed as two separate electrodes in order to function as both antenna and proximity sensor. Acting as a sensor, capacitive samples can be collected at a high refresh rate using the two electrodes as separate capacitive sensors. After an object is detected over one or both electrodes, a determination is made of a tag location (e.g., on the left or right side if one sensor generates a dominant signal, or in a center location if the signals are similar). A corresponding electrode is then turned on as an NFC antenna to confirm a tag is present, and to deliver power to the NFC tag (if necessary), and then to authenticate it. If authentication is successful, the capacitive sensing is again turned on while NFC is turned off, to enable one more proximity readings to be sampled and to confirm the intent of the user. When no gesture detection is being used there could be three possible intended commands which could be recognized (corresponding to left, right, and center locations). These three could be mapped to Local Door Unlock, Global Unlock, and Lock All Doors commands, for example.

The invention could further reduce costs by using existing capacitive sensors in the door handle which are already present for a Passive Entry Passive Start (PEPS) system. Alternatively, existing sensors used for a PEPS system could be eliminated and replaced by the proximity sensors for the NFC reader.

### BRIEF DESCRIPTION OF THE DRAWINGS

FIG. 1 depicts a vehicle system having keyless entry using an NFC card reader installed on a B pillar interacting with a mobile device in the form of a smartphone including an NFC tag.

FIG. 2 is a block diagram showing power polling of an NFC reader while a parked vehicle awaits an attempt of a user to access the vehicle to limit power consumption.

FIG. 3 is a schematic diagram showing an NFC pairing region between and NFC tag and an NFC reader.

FIG. 4 is a schematic diagram showing three subregions within an NFC pairing region to be associated with respective security commands.

FIG. 5 is a plan view showing an NFC antenna and a plurality of proximity sensor elements mounted on a substrate.

FIG. 6 shows an NFC tag placed in a left subregion of an NFC pairing region of the substrate of FIG. 5.

FIG. 7 shows an NFC tag placed in a center subregion of an NFC pairing region of the substrate of FIG. 5.

FIG. 8 is a State diagram showing operation of a security system according to one embodiment.

FIG. 9 is a flowchart showing one preferred method of the invention.

FIG. 10 is a plan view of a circuit board for an NFC reader with conductive elements configured to operate as proximity sensors in one mode and NFC antenna elements in a second mode.

FIG. 11 is a perspective, exploded view of a portion of a card reader on a vehicle.

### DETAILED DESCRIPTION OF PREFERRED EMBODIMENTS

NFC vehicle-entry functions enable a user to unlock and/or unlock various closures (e.g., doors, liftgates, and trunks) using an NFC-enabled tag (e.g., key card or smartphone) as a vehicle key. In prior systems, a user could unlock a door by holding their NFC-enabled device near an exterior NFC reader of the vehicle. In the present invention, a user can select among a plurality of available security commands by associating different tag locations or movements at the NFC reader with respective commands.

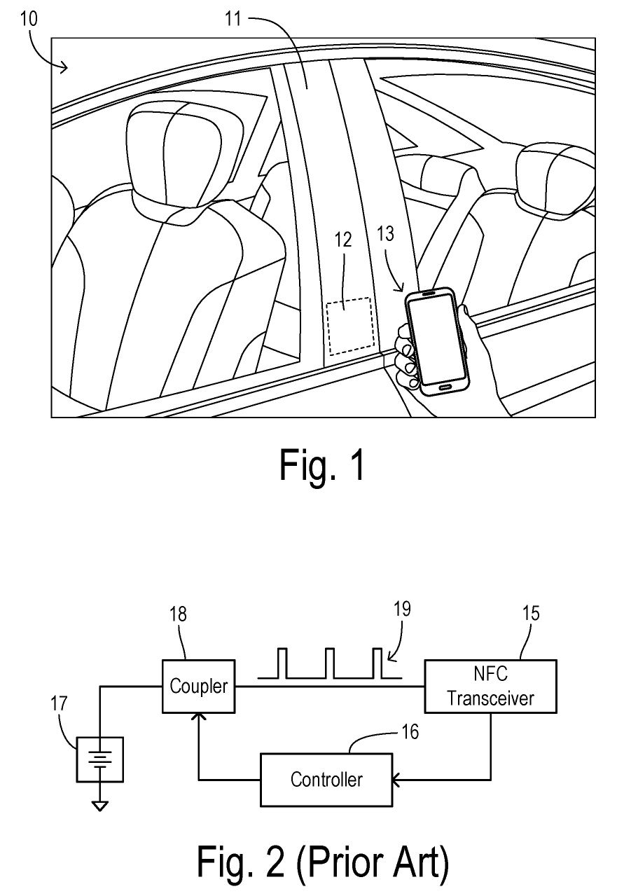

Referring to FIG. 1, a vehicle 10 includes a B pillar 11 containing an NFC reader unit 12 which may be fastened to an underlying sheet metal body panel and covered by a decorative applique. A mobile NFC tag, such as a smartphone 13, can be brought into close proximity to reader unit 12 in order to exchange wireless signals including a Digital Key for accessing secure features of vehicle 10.

FIG. 2 shows an NFC transceiver 15 coupled with a controller 16 within NFC reader 12. A power source 17 such as a battery is controllably applied to NFC transceiver 15 via a coupler 18 which has a state under control of controller 16. Controller 16 selectively couples power source 17 to NFC transceiver according to a polling sequence 19 whereby coupler 18 sends power to NFC transceiver 15 for brief “reading” periods at regular intervals. In the prior art, the need to limit power consumption during idle periods of the vehicle typically necessitates polling intervals which are longer than what would be desirable.

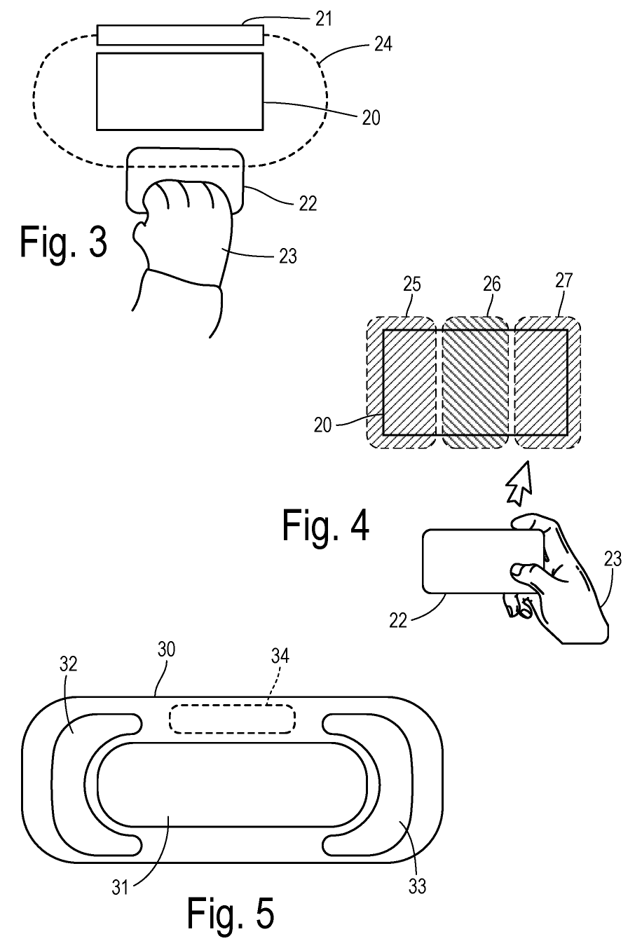

FIG. 3 depicts an arrangement utilized in the present invention wherein an NFC reader 20 has associated proximity sensors 21 configured to determine when an NFC tag 22 held by a user 23 is introduced into an NFC pairing region 24 established by NFC reader 20. Proximity sensors 21 can utilize sensing technologies using much lower current draws than NFC reader 20. Thus, a relatively lower current draw can be maintained even while operating proximity sensors 21 at a faster polling rate than what could be utilized with only an NFC reader.

As shown in FIG. 4, proximity sensors 21 are configured to detect presence of the NFC tag in a plurality of subregions 25, 26, and 27 within pairing region 24 of NFC reader 20. Thus, user 23 may place NFC tag 22 in left subregion 25 for obtaining one security command, center subregion 26 for another security command, and right subregion 27 for yet another security command. Furthermore, the proximity sensors may be configured to monitor movement of tag 22, enabling the user 23 to perform various swiping movements to access yet other security commands. The security commands can include, without limitation, a single door unlock command, a global door unlock command, and a global lock command.

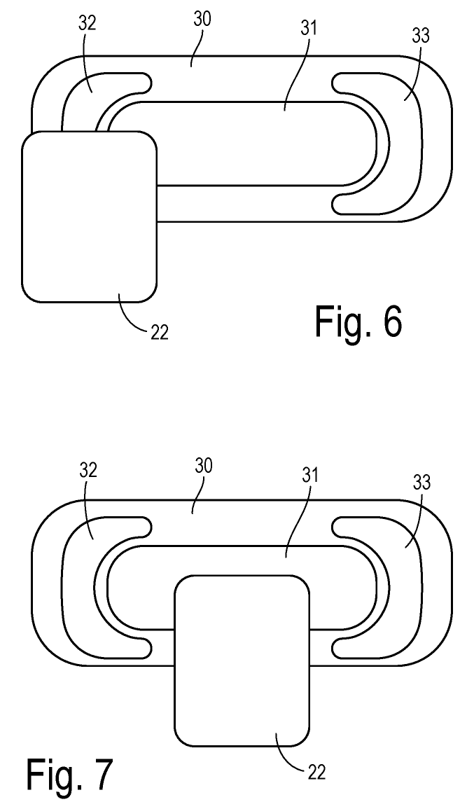

FIG. 5 shows a printed circuit board or other substrate 30 containing electromagnetic components of an NFC reader including an NFC antenna 31, a capacitive electrode 32 of a first proximity sensor, and a capacitive electrode 33 of a second capacitive sensor. Substrate 30 may optionally include another capacitive electrode 34 (e.g., located at a center of the pairing region established by antenna 31) when utilizing a third proximity sensor. As shown in FIG. 6, when NFC tag 22 is located in close proximity with capacitive electrode 32, its presence can be detected. Assuming NFC authentication is successfully performed by interaction between tag 22 and NFC antenna 31, then a security command associated with the left proximity sensor (using electrode 32) can be executed.

The proximity sensors in the invention distinguish between at least two subregions within the NFC pairing region in order to select between two different security commands. Using a higher number of subregions and/or separately identifiable gestures (e.g., swiping left or swiping right) can be obtained using a higher number of proximity sensors. As used herein, “proximity sensors” means sensing apparatus which not only detects but also locates an NFC tag before or after it conducts any actual NFC communication. For example, an image sensor could comprise the proximity sensors since multiple pixels of an image sensor distinguish between multiple locations where an NFC tag could be detected.

In some embodiments, a greater number of subregions could be detected than the number of separate proximity sensors. As shown in FIG. 7, capacitive electrode 32 and capacitive electrode 33 of first and second proximity sensors could be sensitive enough to detect presence of NFC tag 22 when it is equally spaced between them. When the change in capacitance detected by each of the proximity sensors is approximately equal then the third subregion at the center of the arrangement can be detected.

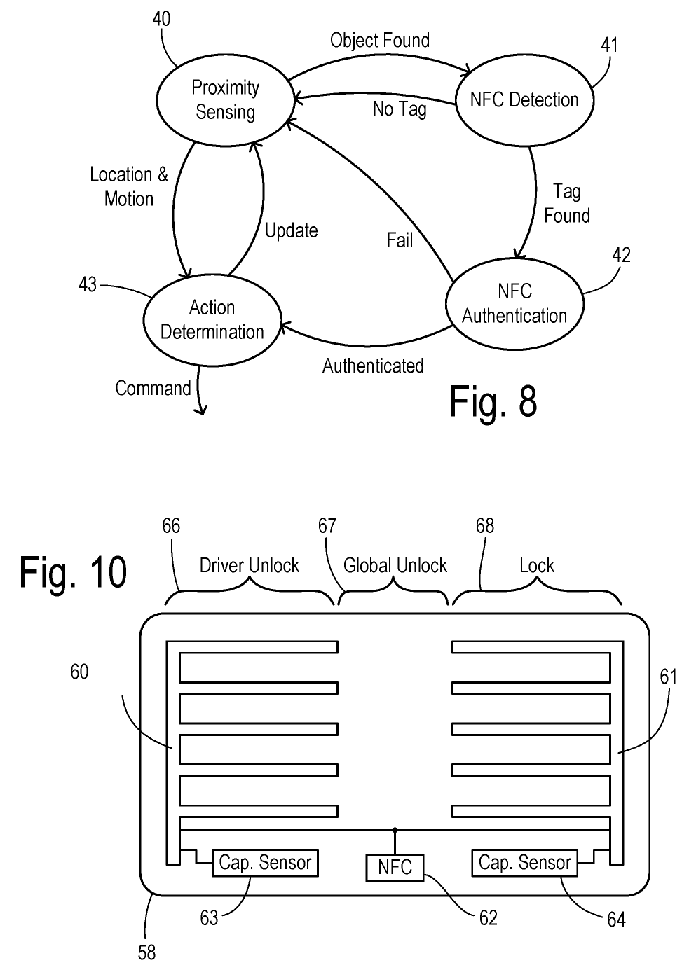

FIG. 8 illustrates a state diagram according to one example embodiment of the invention. Once a vehicle is parked, unoccupied, and in a locked condition, proximity sensing begins to be performed in a State 40. To achieve a sufficiently low current draw while monitoring for object, power supplied to the proximity sensors can be intermittent according to a predetermined polling interval. Proximity sensing comprises monitoring for objects which may enter the NFC pairing region of the NFC reader. When an object is found then a transition is made to a State 41 wherein the NFC reader is activated. NFC communication signals are transmitted by the reader for identifying and interacting with any NFC tag which may be present in the NFC pairing region. If a tag is found then a transition is made to a State 42 in which an NFC authentication process is performed. If no tag is detected then a return is made to State 40. If authentication fails then a transition may be made back to State 40 to wait for a subsequent object.

When an NFC tag is properly authenticated then a transition is made to a State 43 four selecting an action to be taken. In some embodiments, the subregion found in the initial object detection can be all that is needed to select a respective security command, and the corresponding command output from State 43. In some embodiments, a position update may first be determined by returning to State 40. After updating a location and any motion of the NFC tag, the details are returned to State 43 to be used in selection of the appropriate security command being requested by the user. The selected security command is passed on to an appropriate system in the vehicle which performs the selected function.

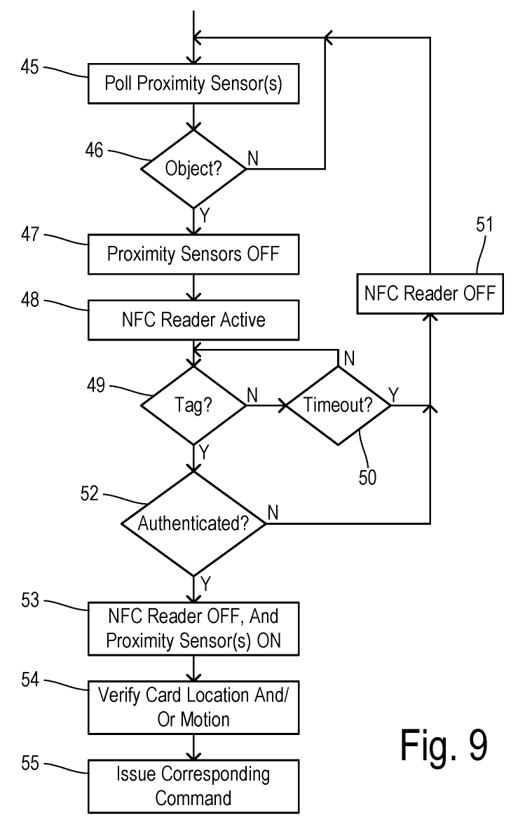

FIG. 9 shows one preferred method of the invention wherein the proximity sensors are polling in step 45. A check is performed in step 46 to determine whether an object has been detected. If not then a return is made to step 46. Once an object is detected in step 46 then the proximity sensors are turned off in step 47. This helps avoid any potential interference with operation of the NFC communication. In step 48, the NFC reader is activated and a check is performed in step 49 to determine whether an NFC tag is detected. If not, then a check is performed in step 50 to determine whether a predetermined time period has expired. The predetermined time period begins with the activation of the NFC reader had continues for a predetermined time sufficient to perform an NFC message exchange assuming a rag in present. If the time period has timed out, then the NFC reader is turned off in step 51 and a return is made to step 45. If the predetermined period has not timed out then a return is made to step 49.

Once an NFC message exchange is achieved then the NFC codes obtained from the NFC tag are checked for authentication in step 52. If the NFC tag is not authenticated than the NFC reader is turned off in step 51. Upon a successful authentication, the NFC reader is deactivated in step 53 and the proximity sensors may be turned back on. In step 54, an updated location and/or movement of the NFC tag are determined in step 54. Based on the locations and/or motions detected, the corresponding security command is issued in step 55.

In some embodiments, an NFC antenna and proximity sensors may utilize common components as shown in FIG. 10. A substrate 58 carries an electrode 60 and an electrode 61 each having a layout capable of performing NFC signal transmission/reception in combination as well as capacitive sensing operating separately. For example, electrodes 60 and 61 are commonly connected to NFC receiver circuitry 62 (also on substrate 58 or elsewhere). When receiver circuitry 62 is active, an NFC pairing region is established around substrate 58 in an area defined by electrodes 60 and 61. Furthermore, electrode 60 may be connected to a first capacitive sensor circuit 63 while electrode 61 is coupled to a second capacitive sensor circuit 64 which operate using known techniques when receiver circuitry is inactive. Sensor circuits 63 and 64 can be operated at lower power consumption for performing proximity sensing than what is required by NFC receiver circuitry 62 when using electrode 60 and 61 as an NFC antenna. When used as capacitive sensing electrodes, up to three subregions can be distinguished including a subregion 66 (proximate to electrode 60) associated with a driver door unlocked command, a subregion 67 (proximate to electrode 61) corresponding to a global unlock command for all doors, and a subregion 68 (centered between electrodes 60 and 61) associated with locking of all the doors.

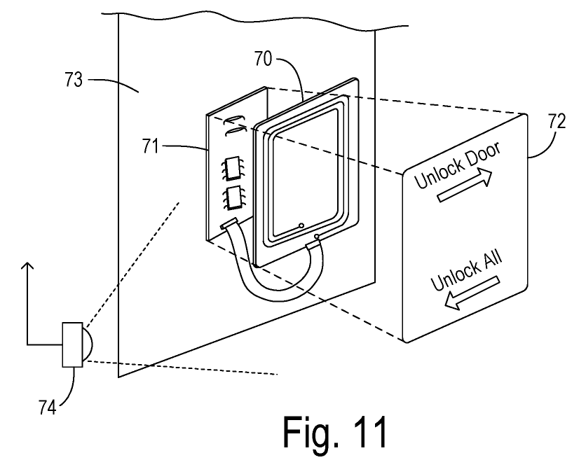

FIG. 11 shows another embodiment of the invention wherein an NFC reader includes an NFC antenna substrate 70, a controller substrate 71 which includes receiver circuitry, and a cover appliqué 72. The NFC reader is shown in exploded form, and attaches to a vehicle surface 73. The proximity sensors comprise a camera or image sensor 74 mounted to the vehicle which distinguishes between multiple locations or pixels to locate an NFC tag and track its location. Cover appliqué 72 carries text, legends, and/or symbols informing a user of the locations or gestures which correspond to available security commands. For example, FIG. 11 shows that a swipe to the right will obtain a single-door-unlocking command and a swipe to the left will obtain an unlock-all-doors command. Text, symbols, and/or other legends may be illuminated in response to low ambient light conditions or in response to detection of an object as known in the art.

What is claimed is:

1. Security apparatus for a vehicle which is responsive to a near field communication (NFC) tag, comprising:
an NFC antenna disposed at an outer surface of the vehicle establishing an NFC pairing region;
receiver circuitry coupled to the antenna and configured to decode NFC signals from the NFC tag when the NFC tag is positioned in the NFC pairing region, wherein the receiver circuitry has an awake mode for receiving the NFC signals and a sleep mode in which the NFC signals are not received;
a plurality of proximity sensors configured to detect presence of the NFC tag according to a plurality of subregions within the NFC pairing region, wherein the proximity sensors detect presence of the NFC tag independent of any NFC signals; and
a control circuit configured to (1) change the receiver circuitry from the sleep mode to the awake mode in response to the proximity sensors detecting the NFC tag in the NFC pairing region, and (2) select a user security command to be accessed using the NFC tag according to at least one of the subregions where the proximity sensors detected the NFC tag.

2. The security apparatus of claim 1 wherein the plurality of proximity sensors has an active mode and an inactive mode wherein a power draw of the plurality of proximity sensors is higher in the active mode than in the inactive mode, and wherein the control circuit is configured to alternate the plurality of proximity sensors between the active mode and the inactive mode according to a polling schedule until the NFC tag is detected.

3. The security apparatus of claim 1 wherein the plurality of proximity sensors has an active mode and an inactive mode wherein a power draw of the plurality of proximity sensors is higher in the active mode than in the inactive mode, and wherein the control circuit is configured to select the inactive mode during a time that the receiver circuitry is in the awake mode for receiving the NFC signals.

4. The security apparatus of claim 3 wherein the control circuit is configured to select the active mode of the plurality of proximity sensors after receiving the NFC signals to update the detection of the subregion where the NFC tag is present.

5. The security apparatus of claim 1 wherein the plurality of proximity sensors are configured to establish two subregions within the NFC pairing region, and wherein the control circuit associates each subregion with a respective user security command.

6. The security apparatus of claim 1 wherein the plurality of proximity sensors are configured to establish two subregions within the NFC pairing region, and wherein the control circuit associates a movement of the NFC tag from one of the subregions to the other of the subregions with a respective user security command.

7. The security apparatus of claim 1 wherein the plurality of proximity sensors comprises a capacitive sensor.

8. The security apparatus of claim 7 wherein the capacitive sensor comprises an electrode which also functions as at least a portion of the NFC antenna.

9. The security apparatus of claim 1 wherein the plurality of proximity sensors comprises an optical sensor or an ultrasonic sensor.

10. The security apparatus of claim 1 wherein the user security command is selected from a group comprising a single door unlock command, a global door unlock command, and a global lock command.

11. A vehicle security method for a vehicle having a near field communication (NFC) antenna disposed at an outer surface of the vehicle establishing an NFC pairing region and receiver circuitry coupled to the antenna which is configured to decode NFC signals from an NFC tag when the NFC tag is positioned in the NFC pairing region, wherein the receiver circuitry has an awake mode for receiving the NFC signals and a sleep mode in which the NFC signals are not received, the method comprising the steps of:
detecting presence of the NFC tag according to a plurality of subregions within the NFC pairing region using a plurality of proximity sensors, wherein the proximity sensors detect presence of the NFC tag independent of any NFC signals: changing the receiver circuitry from the sleep mode to the awake mode in response to the proximity sensors detecting the NFC tag in the NFC pairing region; and
selecting a user security command to be accessed using the NFC tag according to at least one of the subregions where the proximity sensors detected the NFC tag.

12. The method of claim 11 wherein the plurality of proximity sensors has an active mode and an inactive mode, wherein a power draw of the plurality of proximity sensors is higher in the active mode than in the inactive mode, the method further comprising the step of:
alternating the plurality of proximity sensors between the active mode and the inactive mode according to a polling schedule until the NFC tag is detected.

13. The method of claim 11 wherein the plurality of proximity sensors has an active mode and an inactive mode, wherein a power draw of the plurality of proximity sensors is higher in the active mode than in the inactive mode, the method further comprising the step of:
selecting the inactive mode during a time that the receiver circuitry is in the awake mode for receiving the NFC signals.

14. The method of claim 13 further comprising the step of:
selecting the active mode of the plurality of proximity sensors after receiving the NFC signals to update the detection of the subregion where the NFC tag is present.

15. The method of claim 11 wherein the plurality of proximity sensors are configured to establish two subregions within the NFC pairing region, and wherein each subregion is associated with a respective user security command.

16. The method of claim 11 wherein the plurality of proximity sensors are configured to establish two subregions within the NFC pairing region, and wherein a movement of the NFC tag from one of the subregions to the other of the subregions is associated with a respective user security command.

17. The method of claim 11 wherein the plurality of proximity sensors comprises a capacitive sensor.

18. The method of claim 17 wherein the capacitive sensor comprises an electrode which also functions as at least a portion of the NFC antenna.

19. The method of claim 11 wherein the plurality of proximity sensors comprises an optical sensor or an ultrasonic sensor.

20. The method of claim 11 wherein the user security command is selected from a group comprising a single door unlock command, a global door unlock command, and a global lock command.
